(19) United States
(12) Patent Application Publication
(10) Pub. No.: US 2007/0089584 A1
(43) Pub. Date: Apr. 26, 2007

(54) Saw table apparatus

(76) Inventor: David Squire Howard, LaVerkin, UT (US)

Correspondence Address: David O. Simmons;Galasso & Associates LP, P.O. Box 26503, Austin, TX, 78755-0503, US

(21) Appl. No.: 11/254,904

(22) Filed: Oct. 20, 2005

(51) Int. Cl. B23D 45/06

(52) U.S. Cl. 83/477.2; 83/574

(57) ABSTRACT

A saw table apparatus comprises a table and a saw mounting structure. The table includes a base and a tabletop attached to the base. The tabletop has a work-piece support surface. The saw mounting structure is engaged with the tabletop. The saw mounting structure is configured for having a hand-held circular saw attached thereto such that, when the saw mounting structure is in a use position with respect to the tabletop, a blade of the hand-held circular saw extends above a work-piece support surface of the tabletop and a work-piece engagement surface of the saw mounting structure lies substantially flush with the work-piece support surface of the tabletop. An engagement portion of the electrical plug receptacle is expose within an interior space of the base and a control portion of the electrical switch is exposed an exterior surface of the base.

### FIELD OF THE DISCLOSURE

The disclosures made herein relate generally to power saws and, more particularly, to attachments for enhancing and extending the functionality of power saws.

### BACKGROUND

To ensure proper fit and finish when undertaking a carpentry project, a person involved in a carpentry project (e.g., a carpenter, a homeowner, etc) needs to make cuts in a precise and clean manner. Modem day saws enable such precise and clean cuts to be readily and repeatedly made. In doing so, a finished carpentry project exhibits a professional appearance and/or functionality.

A hand-held circular saw, which is a relatively smaller and more portable version of a table saw, is arguably one of the most important tools that a carpenter uses. For any number of types of cutting tasks, a hand-held circular saw will generally offer suitable or preferred utility. However, for certain types of cutting tasks, a table saw is preferred due to its ability to provide for repeatability and precision in making, for example, long straight cuts.

A hand-held circular saw and a table saw are both relatively expensive equipment. Accordingly, purchasing both of these types of saws can present a sizable investment for a craftsperson or homeowner. Therefore, an apparatus configured for enabling a hand-held circular saw to provide table saw functionality is useful and advantageous.

### SUMMARY OF THE DISCLOSURE

Embodiments of the present invention enable a hand-held circular saw to provide table saw functionality. More specifically, embodiments of the present invention provide for a saw table configured for having a hand-held circular saw mounted to it in a manner that enables table saw functionality. In doing so, embodiments of the present invention advantageously preclude the need to purchase both a table saw and a hand-held circular saw while providing for the functionality of both a hand-held circular saw and a table saw.

In one embodiment of the present invention, a saw table apparatus comprises a table and a saw mounting structure. The table includes a base and a tabletop attached to the base. The tabletop has a work-piece support surface. The saw mounting structure is engaged with the tabletop. The saw mounting structure is configured for having a hand-held circular saw attached thereto such that, when the saw mounting structure is in a use position with respect to the tabletop, a blade of the hand-held circular saw extends above a work-piece support surface of the tabletop and a work-piece engagement surface of the saw mounting structure lies substantially flush with the work-piece support surface of the tabletop.

In another embodiment of the present invention, a saw table apparatus comprises a table, a saw mounting structure, a power supply assembly and a work-piece guide. The table includes a base and a tabletop attached to the base. The tabletop has a work-piece support surface. The saw mounting structure includes a mounting plate. The mounting plate is pivotally attached to the tabletop whereby the mounting plate is movable between a use position such that a work-piece support surface of the mounting plate lies substantially flush with the work-piece support surface of the tabletop and a saw mounting position such that a saw engaging portion of the mounting plate is accessible from above the work-piece support surface of the tabletop. The power supply assembly is attached to the table. The power supply assembly includes an electrical plug receptacle and an electrical switch. The electrical switch is electrically coupled to the electrical plug receptacle for enabling power to be selectively provided to the electrical plug receptacle. The work-piece guide is movably attached to the table. The work-piece guide extends over the work-piece support surface of the tabletop and is laterally adjustable with respect to a width dimension of the tabletop.

In another embodiment of the present invention, a table saw system comprises a hand-held circular saw, a table, a saw mounting structure and a power supply assembly. The table includes a base and a tabletop attached to the base. The tabletop has a work-piece support surface. The saw mounting structure is engaged with the tabletop. The hand-held circular saw is releasably engaged with a saw engaging portion of the saw mounting structure. A work-piece support surface of the saw mounting structure lies substantially flush with the work-piece support surface of the tabletop and a blade of the hand-held circular saw extends above a work-piece support surface of the tabletop. The power supply assembly is attached to the table. The power supply assembly includes an electrical plug receptacle and an electrical switch. The electrical switch is electrically coupled to the electrical plug receptacle for enabling power to be selectively provided to the electrical plug receptacle. A power supply plug of the hand-held circular saw is removable engaged with the electrical plug receptacle of the power supply assembly.

Turning now to specific aspects of the present invention, in at least one embodiment, the tabletop includes a central opening therein and the saw mounting structure includes a mounting plate fixedly positionable within the central opening.

In at least one embodiment of the present invention, the mounting plate is pivotally attached to the tabletop whereby the mounting plate is movable between a use position such that a work-piece support surface of the saw mounting structure lies substantially flush with the work-piece support surface of the tabletop and a saw mounting position such that a saw engaging portion of the mounting plate is accessible from above the work-piece support surface of the tabletop.

In at least one embodiment of the present invention, the saw mounting structure includes spaced apart flanges defining respective slots extending between each one of the flanges and the mounting plate whereby a bottom plate of a hand-held circular saw is capturable within the slots for enabling the hand-held circular saw to be attached to the saw mounting structure.

In at least one embodiment of the present invention, the saw mounting structure includes a plurality of mounting brackets and each one of the flanges is attached to one of the mounting brackets.

In at least one embodiment of the present invention, a power supply assembly is attached to the table, the power supply assembly includes an electrical plug receptacle and an electrical switch and the electrical switch is electrically coupled to the electrical plug receptacle for enabling power to be selectively provided to the electrical plug receptacle.

In at least one embodiment of the present invention, an engagement portion of the electrical plug receptacle is expose within an interior space of the base and a control portion of the electrical switch is exposed at an exterior surface of the base.

In at least one embodiment of the present invention, the power supply assembly includes a power supply cord electrically connected to the electrical switch for enabling electrical power to be provided to the electrical switch.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view depicting a saw table apparatus in accordance with the present invention.

FIG. 2 is a side view of the saw table apparatus depicted in FIG. 1.

FIG. 3 depicts an embodiment of a saw mounting structure in accordance with the present invention.

FIG. 4 is a cross sectional view taken along the line 4-4 in FIG. 3.

### DETAILED DESCRIPTION OF THE DRAWING FIGURES

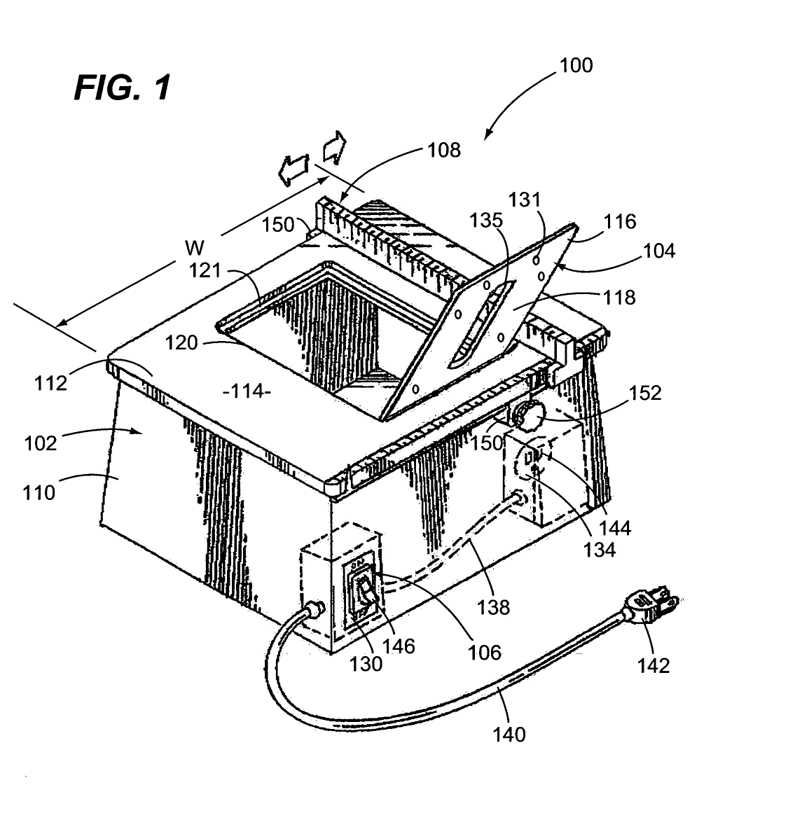

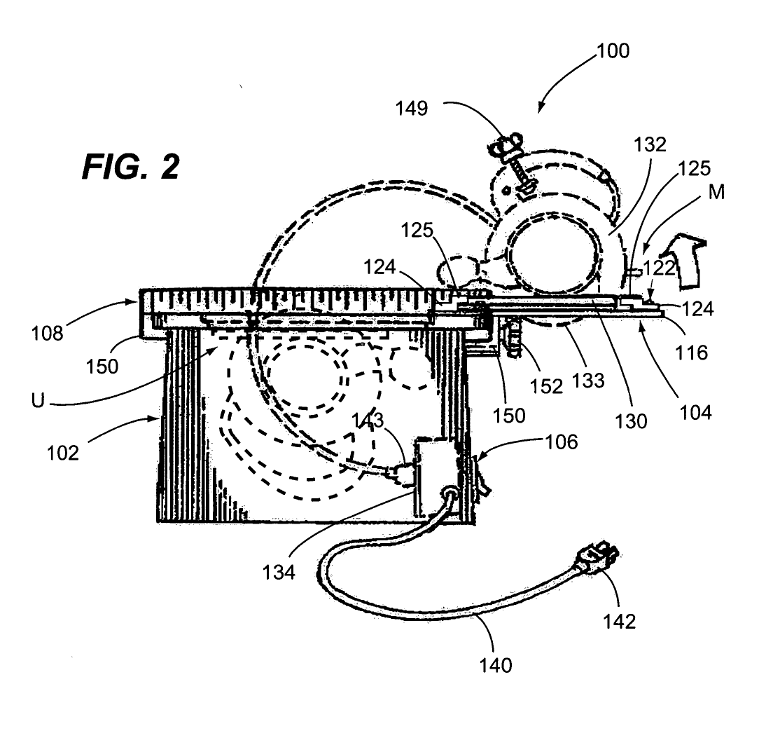

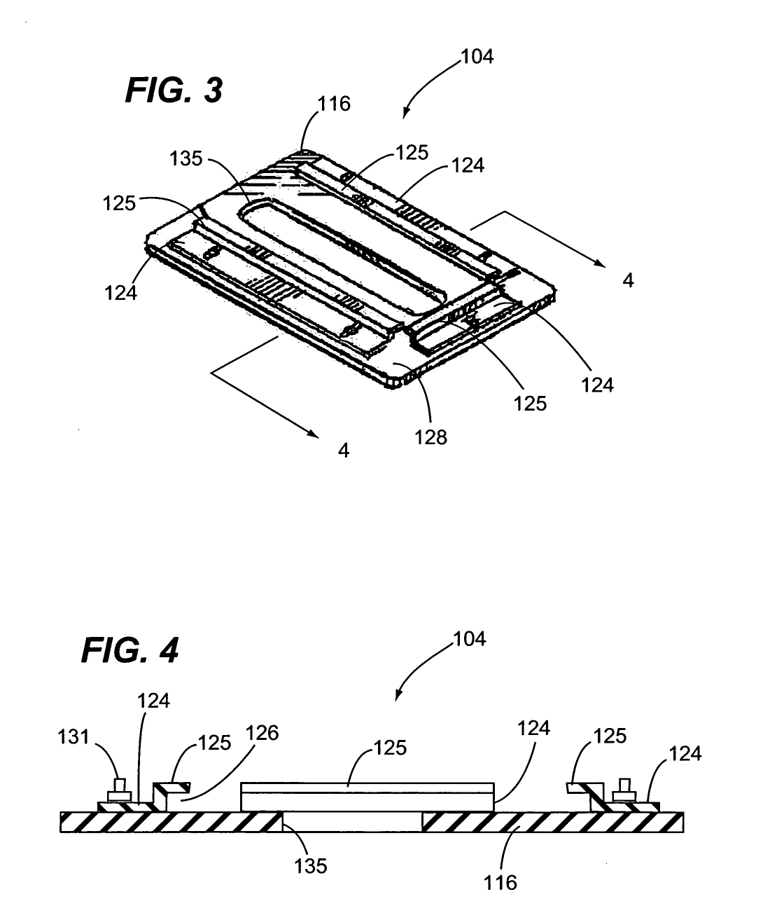

FIGS. 1 and 2 depict an embodiment of a saw table apparatus in accordance with the present invention, which is referred to herein as the saw table apparatus 100. The saw table apparatus 100 includes a table 102, a saw mounting structure 104, a power supply assembly 106 and a work-piece guide 108. The table 102 includes a base 110 and a tabletop 112 attached to the base 110. The tabletop 112 has a work-piece support surface 114 that is generally flat and smooth.

The saw mounting structure 104 includes a mounting plate 116. The mounting plate 116 is pivotally attached to the tabletop 112 by means such as, for example, one or more hinges 117. Accordingly, the mounting plate 116 is movable between a use position U (FIG. 2) and a saw mounting position M (FIG. 2). In the use position U, a work-piece support surface 118 of the mounting plate 116 lies substantially flush with the work-piece support surface 114 of the tabletop 112. When in the use position, the mounting plate 116 is fixedly positionable within a central opening 120 of the tabletop 112 and rests on a perimeter flange 121 of the central opening 120. When in the saw mounting position M, the mounting plate 116 is pivoted away from the central opening 120 and a saw engaging portion 122 of the mounting plate 116 (i.e., a bottom portion of the mounting plate 116) is accessible from above the work-piece support surface 114 of the tabletop 112. Optionally, the means for enabling the mounting plate 116 to be pivotal between the use position U and the saw mounting position M is omitted. A lock-down mechanism (not specifically shown) is provided for securing the mounting plate 116 in the use position U.

As depicted in FIGS. 2 and 4, in addition to the mounting plate 116, the saw mounting structure 104 includes a plurality of mounting brackets 124. Each one of the mounting brackets 124 has a flange portion 125 that defines a respective slot 126 extending between the flange portion 125 and a rear surface 128 the mounting plate 116. A bottom plate 130 (i.e., a guide plate) of a hand-held circular saw 132 (FIG. 2) is captured within each slot thereby enabling the hand-held circular saw 130 to be attached to the saw mounting structure 104. In one embodiment, fasteners 131 (e.g., flathead screws) extend through the mounting plate 116 and the flanges 124 for securing each mounting bracket 124 in place. The flanges 125 are each configured for applying a compressive for on the bottom plate 130 of the hand-held circular saw 132 130 to hold the hand-held circular saw 132 in a static position with respect to the mounting plate 116. In another embodiment (not specifically shown), the mounting brackets 124 are omitted and a plurality of fasteners extend through the mounting plate 116 and bottom plate 130 of the hand-held circular saw 132 for holding the hand-held circular saw 132 in a static position with respect to the mounting plate 116. Preferably, the mounting brackets 124 are adjustable to accommodate different size saws.

When the mounting plate 116 is in the use position U, a blade 133 of the hand-held circular saw 132 extends above the work-piece support surface 114 of the tabletop 112 and a work-piece engagement surface 118. The blade 133 extends through a blade opening 135 in the mounting plate 116. Preferably, the blade opening 133 is wide enough to accommodate angling of blade via angular rotation of the hand-held circular saw 132. A flush work-piece support surface is provided in view of the work-piece support surface 114 of the table top 112 being substantially flush with the work-piece support surface 118 of the mounting plate 116.

As depicted in FIGS. 1 and 2, the power supply assembly 106 includes an electrical plug receptacle 134, an electrical switch 136, an electrical cable 138 connected between the electrical plug receptacle 134 and the electrical switch 136, and power cord 140. The electrical switch 136 is electrically coupled to the electrical plug receptacle 134 through the electrical cable 138. The power cord 140 is electrically connected to the electrical switch 136 at a first end and has an electrical plug 142 at a second end. A power cord plug 143 of the hand-held circular saw 132 is plugged into the electrical plug receptacle 134. In this manner, electrical power may be selectively provided to the hand-held circular saw 132 through the power supply assembly 106.

Advantageously, an engagement portion 144 of the electrical plug receptacle 134 (i.e., i.e., the prong receptacles) is expose within an interior space of the base 110. Similarly, a control portion 146 of the electrical switch 136 (i.e., the hand-movable selector) is exposed an exterior surface of the base 110. In this configuration, a power cord 148 of the hand-held circular saw 132 is contained within the interior space of the base 110 and the control portion 146 of the electrical switch 136 is conveniently accessible. A trigger lock mechanism 149 is provided for holding a trigger of the hand-held circular saw 132 in an on position such that activation of the hand-held circular saw 132 is controlled exclusively through the electrical switch 136. It is disclosed herein that the trigger lock mechanism 149 may be integral with the hand-held circular saw 132 or may be an add-on mechanism.

The work-piece guide 108 is movably attached to the tabletop 112. The work-piece guide 112 extends over the work-piece support surface 114 of the tabletop 112 and is laterally adjustable with respect to a width dimension W of the tabletop 112. As depicted in FIGS. 1 and 2, the work-piece guide 108 includes flanges 150 that engage the tabletop 112 in a manner enabling the work-piece guide 108 to laterally translate and a position locking device 152 (e.g., a threaded fastener with knob) to prevent unintentional movement of the work-piece guide 108 with respect to the tabletop 112 such as through, for example, a clamping and/or frictional force applied to the tabletop 112.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A saw table apparatus, comprising:
a table including a base and a tabletop attached to the base, wherein the tabletop has a work-piece support surface; and
a saw mounting structure engaged with the tabletop, wherein the saw mounting structure is configured for having a hand-held circular saw attached thereto such that, when the saw mounting structure is in a use position with respect to the tabletop, a blade of the hand-held circular saw extends above a work-piece support surface of the tabletop and a work-piece engagement surface of the saw mounting structure lies substantially flush with the work-piece support surface of the tabletop.

2. The saw table apparatus of claim 1 wherein:
the tabletop includes a central opening therein; and
the saw mounting structure includes a mounting plate fixedly positionable within the central opening.

3. The saw table apparatus of claim 2 wherein the mounting plate is pivotally attached to the tabletop whereby the mounting plate is movable between a use position such that a work-piece support surface of the saw mounting structure lies substantially flush with the work-piece support surface of the tabletop and a saw mounting position such that a saw engaging portion of the mounting plate is accessible from above the work-piece support surface of the tabletop.

4. The saw table apparatus of claim 2 wherein the saw mounting structure includes spaced apart flanges defining respective slots extending between each one of said flanges and the mounting plate whereby a bottom plate of a hand-held circular saw is capturable within said slots for enabling the hand-held circular saw to be attached to the saw mounting structure.

5. The saw table apparatus of claim 4 wherein:
the saw mounting structure includes a plurality of mounting brackets; and
each one of said flanges is attached to one of said mounting brackets.

6. The saw table apparatus of claim 1, further comprising:
a power supply assembly attached to the table, wherein the power supply assembly includes an electrical plug receptacle and an electrical switch and wherein the electrical switch is electrically coupled to the electrical plug receptacle for enabling power to be selectively provided to the electrical plug receptacle.

7. The saw table apparatus of claim 6 wherein:
an engagement portion of the electrical plug receptacle is expose within an interior space of the base; and
a control portion of the electrical switch is exposed an exterior surface of the base.

8. The saw table apparatus of claim 7 wherein the power supply assembly includes a power supply cord electrically connected to the electrical switch for enabling electrical power to be provided to the electrical switch.

9. The saw table apparatus of claim 7 wherein:
the tabletop includes a central opening therein;
the saw mounting structure includes a mounting plate fixedly positionable within the central opening;
the mounting plate is pivotally attached to the tabletop whereby the mounting plate is movable between a use position such that a work-piece support surface of the saw mounting structure lies substantially flush with the work-piece support surface of the tabletop and a saw mounting position such that a saw engaging portion of the mounting plate is accessible from above the work-piece support surface of the tabletop;
the saw mounting structure includes a plurality of mounting brackets;
each one of mounting brackets includes a flange; and
the flange of each one of said mounting brackets defines a respective slot extending between the flange and the mounting plate whereby a bottom plate of a hand-held circular saw is capturable within said slots for enabling the hand-held circular saw to be attached to the saw mounting structure.

10. A saw table apparatus, comprising:
a table including a base and a tabletop attached to the base, wherein the tabletop has a work-piece support surface;
a saw mounting structure including a mounting plate, wherein the mounting plate is pivotally attached to the tabletop whereby the mounting plate is movable between a use position such that a work-piece support surface of the mounting plate lies substantially flush with the work-piece support surface of the tabletop and a saw mounting position such that a saw engaging portion of the mounting plate is accessible from above the work-piece support surface of the tabletop;
a power supply assembly attached to the table, wherein the power supply assembly includes an electrical plug receptacle and an electrical switch and wherein the electrical switch is electrically coupled to the electrical plug receptacle for enabling power to be selectively provided to the electrical plug receptacle; and
a work-piece guide movably attached to the table, wherein the work-piece guide extends over the work-piece support surface of the tabletop and is laterally adjustable with respect to a width dimension of the tabletop.

11. The saw table apparatus of claim 10 wherein:
the tabletop includes a central opening therein; and
the mounting plate is fixedly positionable within the central opening.

12. The saw table apparatus of claim 10 wherein the saw mounting structure includes spaced apart flanges defining respective slots extending between each one of said flanges and the mounting plate whereby a bottom plate of a hand-held circular saw is capturable within said slots for enabling the hand-held circular saw to be attached to the saw mounting structure.

13. The saw table apparatus of claim 12 wherein:
the saw mounting structure includes a plurality of mounting brackets; and
each one of said flanges is attached to one of said mounting brackets.

14. The saw table apparatus of claim 10 wherein:
an engagement portion of the electrical plug receptacle is expose within an interior space of the base; and
a control portion of the electrical switch is exposed an exterior surface of the base.

15. The saw table apparatus of claim 14 wherein the power supply assembly includes a power supply cord electrically connected to the electrical switch for enabling electrical power to be provided to the electrical switch.

16. The saw table apparatus of claim 14 wherein:
the tabletop includes a central opening therein;
the mounting plate is fixedly positionable within the central opening;
the saw mounting structure includes a plurality of mounting brackets;
each one of mounting brackets includes a flange; and
the flange of each one of said mounting brackets defines a respective slot extending between the flange and the mounting plate whereby a bottom plate of a hand-held circular saw is capturable within said slots for enabling the hand-held circular saw to be attached to the saw mounting structure.

17. A table saw system, comprising:
a hand-held circular saw;
a table including a base and a tabletop attached to the base, wherein the tabletop has a work-piece support surface;
a saw mounting structure engaged with the tabletop, wherein the hand-held circular saw is engaged with a saw engaging portion of the saw mounting structure, wherein a work-piece support surface of the saw mounting structure lies substantially flush with the work-piece support surface of the tabletop and wherein a blade of the hand-held circular saw extends above a work-piece support surface of the tabletop; and
a power supply assembly attached to the table, wherein the power supply assembly includes an electrical plug receptacle and an electrical switch, wherein the electrical switch is electrically coupled to the electrical plug receptacle for enabling power to be selectively provided to the electrical plug receptacle and wherein a power supply plug of the hand-held circular saw is removable engaged with the electrical plug receptacle of the power supply assembly.

18. The saw table apparatus of claim 17 wherein:
an engagement portion of the electrical plug receptacle is expose within an interior space of the base; and
a control portion of the electrical switch is exposed an exterior surface of the base.

19. The saw table apparatus of claim 18 wherein:
the tabletop includes a central opening therein; and
the saw mounting structure includes a mounting plate fixedly positionable within the central opening;
the saw mounting structure includes a plurality of mounting brackets;
each one of mounting brackets includes a flange;
the flange of each one of said mounting brackets defines a respective slot extending between the flange and the mounting plate; and
a bottom plate of the hand-held circular saw is captured within said slots for securing the hand-held circular saw to the mounting plate.

20. The saw table apparatus of claim 19 wherein the mounting plate is pivotally attached to the tabletop whereby the mounting plate is movable between a use position such that a work-piece support surface of the saw mounting structure lies substantially flush with the work-piece support surface of the tabletop and a saw mounting position such that a saw engaging portion of the mounting plate is accessible from above the work-piece support surface of the tabletop.
